(19) United States
(12) Patent Application Publication
(10) Pub. No.: US 2007/0075520 A1
(43) Pub. Date: Apr. 5, 2007

(54) Crank fastening device for a toddler's tricycle

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/240,498

(22) Filed: Oct. 3, 2005

(51) Int. Cl. B62K 7/00

(52) U.S. Cl. 280/282

(57) ABSTRACT

A crank fastening device for a toddler's tricycle includes an axle, front struts, cranks and pedals. The axle comprises a pair of non-round center holes at respective ends. The crank has one end connected to a relative pedal and another end provided with a connecting section and covered with a lid. The lid comprises a threaded section. An axle seat is provided at the bottom of each front strut. The axle seat comprises an inner threaded hole corresponding to the threaded section of the lid. A recess is provided in the inner wall of the hole of the axle. The connecting section of the crank comprises a tenon corresponding to the recess of the hole of the axle.

### BACKGROUND OF THE INVENTION

1. Field of the Invention

The present invention relates to a crank fastening device for a toddler's tricycle, and more particularly to a quick release and fastening device to replace cranks and pedals.

2. Description of the Related Prior Art

All toddler's tricycles on the market are equipped with cranks and pedals at a front wheel for a rider to step on and move the tricycle forward or backward.

However, before they learn how to step the pedals to ride the tricycle forward, they will push the tricycle with their feet on the ground. Due to the design, the pedals will still roll when the wheels are moving, and the pedals may strike the rider's foot accidentally and hurt him/her. Thus, some designs have eliminated the pedals and cranks.

The question is that babies grow up fast and their learning talents are varied. When they start to learn stepping on the pedals, parents have to install the cranks and pedals back, which is inconvenient and troublesome.

### SUMMARY OF THE INVENTION

It is a primary object of the present invention to provide a crank fastening device for a toddler's tricycle, which is easy to fasten and to release cranks and pedals.

It is another object of the present invention to provide a crank fastening device for a toddler's tricycle, which is secure to a user.

It is a further object of the present invention to provide a crank fastening device for a toddler's tricycle, which is cost-effective.

### BRIEF DESCRIPTION OF THE DRAWINGS

FIG. 1 is an exploded view of the present invention;

FIG. 2 is a perspective view of the present invention; and

FIG. 3 is another perspective view of the present invention applied to a toddler's tricycle.

### DETAILED DESCRIPTION OF THE PREFERRED EMBODIMENT

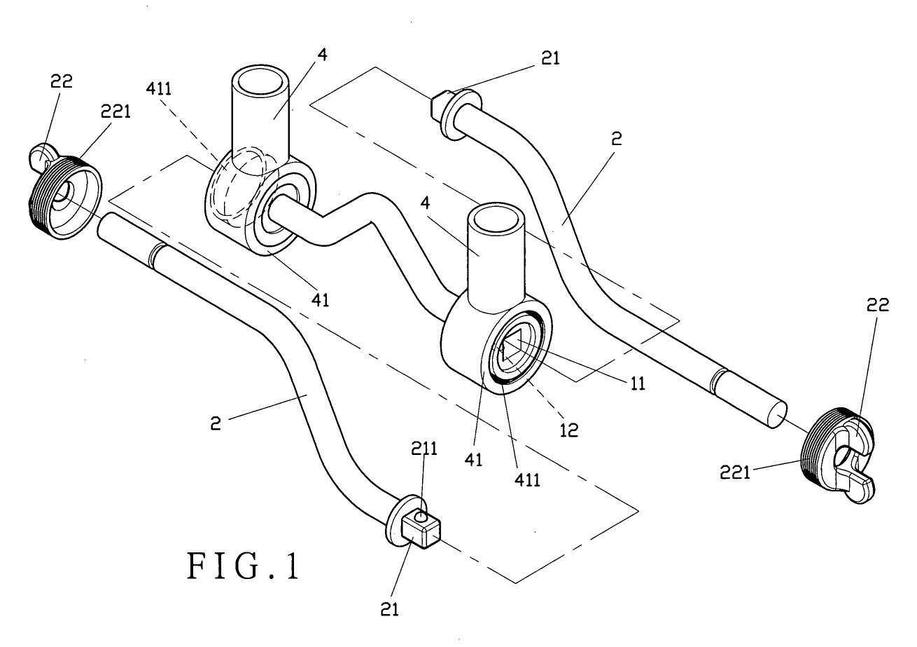

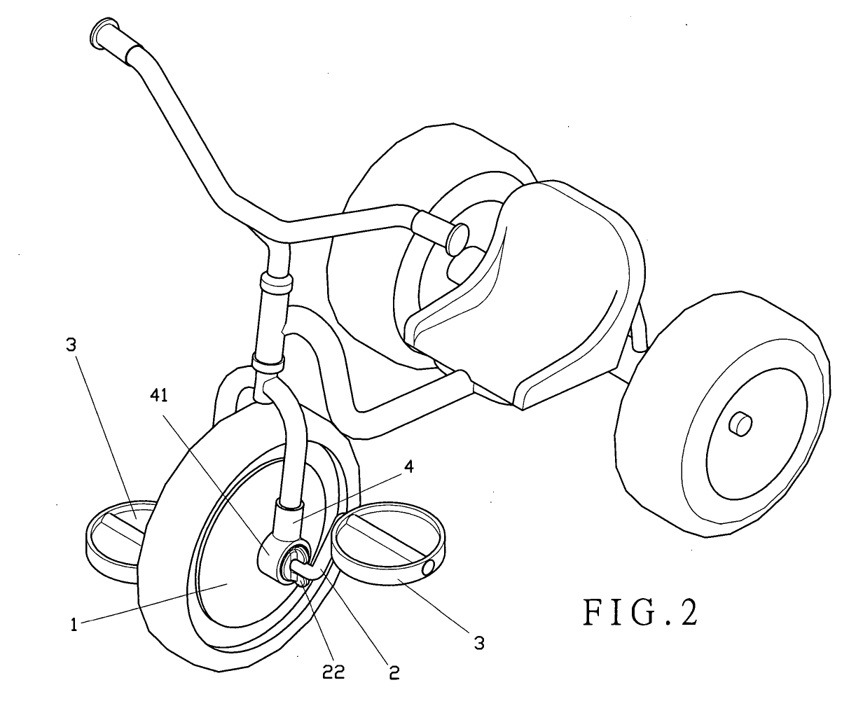

As shown in FIGS. 1 and 2, the present invention comprises an axle 1, cranks 2, pedals 3 and front struts 4.

The axle 1 comprises a pair of non-round center holes 11 at respective ends. A recess 12 is provided in the inner wall of each hole 11 of the axle 1.

Each crank 2 has one end connected to a relative pedal 3 and another end provided with a connecting section 21 and covered with a lid 22. The connecting section 21 comprises a tenon 211 thereon . The lid 22 includes a threaded section 221.

Each front strut 4 is provided with an axle seat 41 at the bottom. The axle seat 41 comprises an inner threaded hole 411 corresponding to the threaded section 221 of the lid 22.

To assemble the present invention, as shown in FIG. 2, the connecting section 21 of each crank 2 is inserted into the hole 11 of the axle 1 with the tenon 211 engaging with the recess 12. The threaded section 221 of the lid 22 is secured to the inner threaded hole 411 of the axle seat 41 so that the crank 2 is secured to the axle 1.

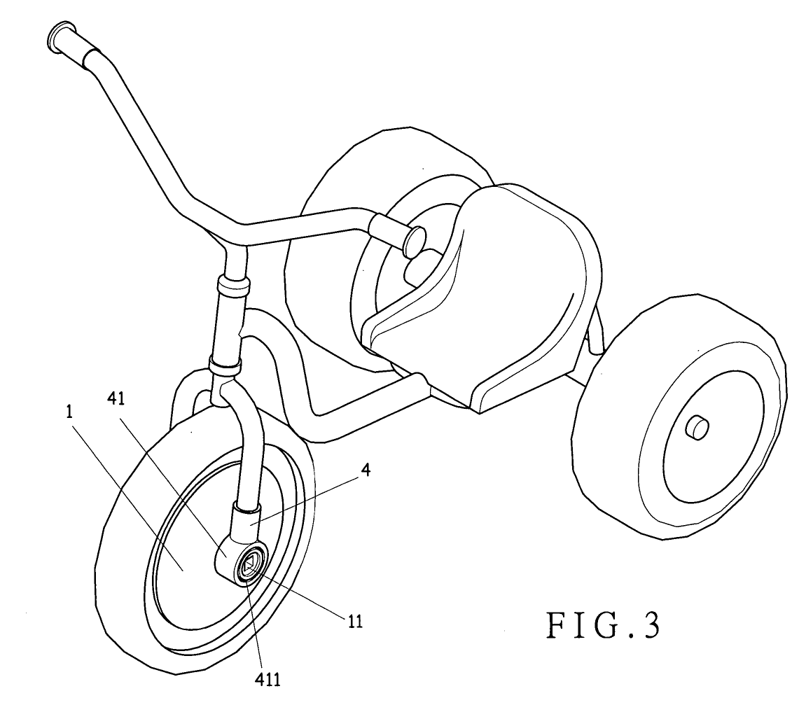

To practice, as shown in FIG. 3, the lid 22 is turned in the counterclockwise direction, which allows the lid 22 to be released from the axle seat 41, and then the pedal 3 can be detached from the axle 1 by force.

1. A crank fastening device for a toddler's tricycle comprising an axle, cranks, pedals and front struts;
said axle comprising a pair of non-round center holes at respective ends;
each crank having one end connected to a relative pedal and another end provided with a connecting section and covered with a lid, said lid comprising a threaded section, each front strut comprising an axle seat at the bottom thereof, said axle seat comprising an inner threaded hole corresponding to said threaded section of said lid.

2. The crank fastening device for a toddler's tricycle, as recited in claim 1, wherein a recess is provided in an inner wall of each said hole of said axle, and said connecting section of each crank comprises a tenon to engage with said recess of each said hole of said axle.
